(19) United States
(12) Patent Application Publication
(10) Pub. No.: US 2026/0110312 A1
(43) Pub. Date: Apr. 23, 2026

(54) SYSTEM FOR DRIVING A HYDRAULIC MEMBER

(71) Applicant: POCLAIN HYDRAULICS INDUSTRIE, Verberie (FR)

(72) Inventors: Gilles Lemaire, Verberie (FR); Bastien Clapit, Verberie (FR); Paul Fournet, Verberie (FR); Yoann Rousseau, Verberie (FR); Julien Viard, Verberie (FR); Pierre Bernard, Verberie (FR); Hubert Demailly, Verberie (FR); Vincent Langlois, Verberie (FR); Joël Lefevre, Verberie (FR)

(73) Assignee: POCLAIN HYDRAULICS INDUSTRIE, Verberie (FR)

(21) Appl. No.: 19/113,211

(22) PCT Filed: Sep. 22, 2023
(86) PCT No.: PCT/FR2023/051462

§ 371 Date: Mar. 19, 2025

(30) Foreign Application Priority Data
Sep. 22, 2022 (FR) FR2209598

(51) Int. Cl. F15B 11/032; F15B 15/18; F16H 39/04; F16H 61/4008; F16H 61/4035; F16H 61/46

(52) U.S. Cl. CPC F15B 11/032; F15B 15/18; F16H 39/04; F16H 61/4008; F16H 61/4035; F16H 61/46

(57) ABSTRACT

System for driving a member (10) by means of a hydraulic circuit, comprising: a hydraulic energy source (100) adapted to deliver a pressure in the hydraulic circuit, a drive member (200), comprising: a casing (210) with a first orifice (212) and a second orifice (214), a primary hydraulic machine (230) housed in the casing (210) and a pressure booster (300) integrated into the casing (210), said pressure booster (300) being adapted to selectively raise the pressure, such that the pressure difference between the two orifices (232, 234) of the primary hydraulic machine (230) is greater than the pressure difference between the two orifices (212, 214) of the casing (210).

### TECHNICAL FIELD

The present invention relates to a system for driving hydraulic members, in particular for driving axles, movement members, jacks, or for driving in rotation more generic equipment such as a winch, a crusher, a drill, etc.

### PRIOR ART

Hydraulic systems are usually composed of a power transformer machine that converts the mechanical energy provided by a primary motor, for example a heat engine or an electric motor, into hydraulic energy distributed by a high-pressure duct network, to one or more hydraulic members such as jacks or hydraulic motors driving wheels or axles.

However this transmission solution has some limitations, in particular:
In torque density: the pressure of the commonly used pipes being limited to values smaller than 450 bar, the maximum transmissible torque limit is the product of this pressure and of the value of the displacement of a hydraulic actuator, typically of the hydraulic motors. However, the displacement value directly impacts the dimension of the motors, as well as their cost.
In speed: for given pump displacement and maximum rpm of the primary motor, a maximum flow rate is defined. In the case of an application for a transmission, this then limits the speed of the vehicle.

In the case of a hydrostatic transmission, two very distinct operating modes are typically distinguished:
An operating mode called “work” mode: the load is significant and the speed is low, here the best crossing capacity (for a vehicle) or in any case the highest torque (for more generic equipment in rotation) are sought, this particular condition is decisive for the sizing of the displacement of the motor.
An operating mode referred to as “road” mode for a vehicle or “normal” mode for more generic equipment in rotation, in particular for the movement of the vehicle or of the machinery between two work locations: in this, the load is low, and the speed is significant. Here it is sought to achieve the fastest speed which will be limited by the size and bulk of the pumps and/or of the motors driving the pumps.

It is therefore understood that these two operating modes constrain the sizing of the hydraulic circuit; the components must be oversized to propose a power margin that is never used by the driver.

More generally, for the driving of a hydraulic member, different drive modes may be required, involving very varied needs in terms of hydraulic power supply.

### DISCLOSURE OF THE INVENTION

In order to at least partially address these issues, the present invention relates to a system for driving a member by means of a hydraulic circuit, comprising:
a hydraulic energy source adapted to deliver a pressure in the hydraulic circuit,
a drive member, comprising:
a casing with a first casing orifice and a second casing orifice that are adapted to define an intake and a discharge of the casing,
a primary hydraulic machine adapted to be supplied by the hydraulic energy source, the primary hydraulic machine being housed in the casing and having a first hydraulic machine orifice and a second hydraulic machine orifice, said system being characterized in that the drive member comprises a pressure booster integrated into the casing,
said pressure booster being adapted to selectively raise the pressure, such that the pressure difference between the two orifices of the primary hydraulic machine is greater than the pressure difference between the two orifices of the casing.

According to one example, the pressure booster is integrated into the casing such that the pressure booster is connected to the first orifice and to the second orifice of the primary hydraulic machine via conduits formed in the casing.

According to one example, the pressure booster is configured to be engaged when the pressure difference between the two orifices of the primary hydraulic machine exceeds a threshold value.

The system may further comprise at least one valve connecting the pressure booster to the first orifice and/or to the second orifice of the casing, said at least one valve being configured, when the pressure difference between the two orifices of the casing is less than or equal to a pressure threshold value, to disengage the pressure booster.

The system may further comprise at least one valve connecting the pressure booster to the first orifice and/or to the second orifice of the casing, said at least one valve being configured, when the rotational speed of the primary hydraulic machine is greater than a threshold value, to disengage the pressure booster.

The system may further comprise at least one valve connecting the pressure booster to the first orifice and/or to the second orifice of the casing, said at least one valve being configured to disengage the pressure booster when the rotational speed of the primary hydraulic machine exceeds a certain threshold.

According to one example, the pressure booster is adapted to take a flow rate Q1 and a pressure P1 at the first or second orifice of the casing, and deliver a flow rate Q2 and a pressure P2 to the first or second orifice of the primary hydraulic machine, such that Q2<Q1 and P2>P1.

According to one example, the primary hydraulic machine may be a hydraulic machine of axial technology, for example having in particular an inclined plate on which the pistons slide.

According to one example, the primary hydraulic machine may be a hydraulic machine of radial technology, for example having in particular a multi-lobed cam in contact with which the pistons slide.

According to one example, the primary hydraulic machine may have a fixed displacement.

According to one example, the primary hydraulic machine may have a multi-displacement.

According to one example, the primary hydraulic machine may have a variable or continuously variable displacement.

According to one example, the pressure booster is of oscillating linear technology.

According to one example, the pressure booster comprises a first hydraulic machine and a second hydraulic machine that are secured in rotation, the first hydraulic machine and the second hydraulic machine having identical displacements, said first and second hydraulic machines being configured so that one has a pump operation and the other has a motor operation.

According to one example, the pressure booster comprises a first hydraulic machine and a second hydraulic machine that are secured in rotation, the first hydraulic machine and the second hydraulic machine having different displacements, said first and second hydraulic machines being configured such that one has a pump operation and the other has a motor operation.

According to one example, the pressure booster comprises a first hydraulic machine and a second hydraulic machine that are secured in rotation, the first hydraulic machine and the second hydraulic machine having different displacements, said first and second hydraulic machines being configured such that one has a pump operation and the other has a motor operation. Said machines may be hydraulic machines of radial technology, and particularly of multi-lobe cam radial technology.

According to one example, the pressure booster comprises a first hydraulic machine and a second hydraulic machine that are secured in rotation, said first and second hydraulic machines being configured such that one has a pump operation and the other has a motor operation. Said hydraulic machines may have a fixed displacement, multi-displacement or variable displacement.

According to one example,
the first hydraulic machine has a first orifice and a second orifice, the first orifice being selectively connected to the orifice of the casing having the highest pressure among the two orifices of the casing, and the second orifice being selectively connected to the orifice of the casing having the lowest pressure among the two orifices of the casing,
the second hydraulic machine has a first orifice and a second orifice, the first orifice being connected to the orifice of the casing having the lowest pressure among the two orifices of the casing, and the second orifice being connected to the orifice of the primary hydraulic machine having the highest pressure via conduits arranged in the casing.

According to one example, the pressure booster comprises a first hydraulic machine and a second hydraulic machine that are secured in rotation, the first hydraulic machine having a greater displacement than the second hydraulic machine,
said system being configured such that, for a first operating mode, the first hydraulic machine has a motor operation, and the second hydraulic machine has a pump operation, said second hydraulic machine supplying the primary hydraulic machine.

According to one example,
the first hydraulic machine has a first orifice and a second orifice, the first orifice being selectively connected to the orifice of the casing having the highest pressure among the two orifices of the casing, and the second orifice being selectively connected to the orifice of the casing having the lowest pressure among the two orifices of the casing,
the second hydraulic machine has a first orifice and a second orifice, the first orifice being connected to the second orifice of the first hydraulic machine, and the second orifice being connected to the inner orifice of the primary hydraulic machine having the highest pressure via conduits arranged in the casing.

According to one example, the second orifice of the second hydraulic machine is connected to the first orifice and to the second orifice of the primary hydraulic machine via a high-pressure selector.

According to one example,
the first orifice of the first hydraulic machine is connected to a first calibrated valve, connected on the one hand to the first orifice of the casing and on the other hand to the second orifice of the casing, said first calibrated valve being configured to connect the first orifice of the first hydraulic machine to the connections linked to the hydraulic energy source having the highest pressure when the pressure difference between the orifices of the casing exceeds a first calibration threshold value,
the second orifice of the first hydraulic machine is connected to a second calibrated valve, connected on the one hand to the first orifice of the casing and on the other hand to the second orifice of the casing, said second calibrated valve being configured to connect the first orifice of the first hydraulic machine to the connections linked to the hydraulic energy source having the lowest pressure when the pressure difference between the orifices of the casing exceeds a second calibration threshold value.

According to one example, the pressure booster comprises a first hydraulic machine and a second hydraulic machine that are secured in rotation, the first hydraulic machine having a displacement greater than the second hydraulic machine,
said system being configured such that, for a first operating mode, the first hydraulic machine has a motor operation, and the second hydraulic machine has a pump operation, said second hydraulic machine supplying the primary hydraulic machine,
   in which:
the first hydraulic machine has a first orifice and a second orifice, the first orifice being connected to the first orifice of the casing, and the second orifice being connected to the second orifice of the casing,
the second hydraulic machine has a first orifice and a second orifice, the first orifice being connected to the second orifice of the primary hydraulic machine, and the second orifice being connected to the first orifice of the primary hydraulic machine,
the system comprising a valve adapted to selectively isolate the first orifice of the casing from the first orifice of the primary hydraulic machine, and a valve adapted to selectively isolate the second orifice of the casing from the second orifice of the primary hydraulic machine.

According to one example, the first hydraulic machine and/or the second hydraulic machine are radial-piston and multilobe-came hydraulic machines.

According to one example, at least one among the first hydraulic machine and the second hydraulic machine is a variable-displacement hydraulic machine.

According to one example, the system further comprises a first valve and a second valve, the first valve being adapted to selectively connect or isolate the first orifice of the casing to the first orifice of the primary hydraulic machine, and the second valve being adapted to selectively connect or isolate the second orifice of the casing to the second orifice of the primary hydraulic machine.

According to one example, the pressure amplification is piloted by a command external to the drive member.

According to one example, the primary hydraulic machine is a radial-piston and multilobe-came hydraulic machine.

The present invention also relates to a rolling machine, for example a vehicle, a construction machinery or an agricultural machine, comprising at least one movement member and at least one system as defined above adapted to selectively drive in rotation said movement member.

The present invention also relates to a drive member as defined above with reference to the system. The invention thus relates in particular to a drive member adapted to selectively drive in rotation a member, the drive member, comprising:
a casing with a first casing orifice and a second casing orifice adapted to define an intake and a discharge of the casing,
a primary hydraulic machine adapted to be supplied by a hydraulic energy source, the primary hydraulic machine being housed in the casing and having a first hydraulic machine orifice and a second hydraulic machine orifice,
said system being characterized in that the drive member comprises a pressure booster integrated into the casing,
said pressure booster being adapted to selectively raise the pressure, such that the pressure difference between the two orifices of the primary hydraulic machine is greater than the pressure difference between the two orifices of the casing.

### BRIEF DESCRIPTION OF THE DRAWINGS

The invention and its advantages will be better understood upon reading the detailed description given below of different embodiments of the invention given as non-limiting examples.

FIG. 1 is a schematic view of one example of a system according to one aspect of the invention.

FIG. 2 represents one exemplary embodiment of a system embodiment according to one aspect of the invention.

FIG. 3 represents one exemplary embodiment of a system according to one aspect of the invention.

FIG. 4 represents another exemplary embodiment of a system according to one aspect of the invention.

FIG. 5 represents another exemplary embodiment of a system according to one aspect of the invention.

FIG. 6 represents another exemplary embodiment of a system according to one aspect of the invention.

FIG. 7 represents another exemplary embodiment of a system according to one aspect of the invention.

FIG. 8 represents one particular configuration of FIG. 6.

FIG. 9 represents one particular configuration of FIG. 6.

FIG. 10 represents another exemplary embodiment of a system according to one aspect of the invention.

FIG. 11 represents one particular configuration of the system shown in FIG. 10.

FIG. 12 represents another particular configuration of the system shown in FIG. 10.

FIG. 13 represents another particular configuration of the system shown in FIG. 10.

FIG. 14 represents another exemplary embodiment of a system according to one aspect of the invention.

FIG. 15 represents one particular configuration of the system shown in FIG. 14.

FIG. 16 represents another particular configuration of the system shown in FIG. 14.

FIG. 17 represents another particular configuration of the system shown in FIG. 14.

FIG. 18 represents another exemplary embodiment of a system according to one aspect of the invention.

FIG. 19 represents another exemplary embodiment of a system according to one aspect of the invention.

Throughout the figures, the elements in common are identified by identical numerical references.

### DESCRIPTION OF THE EMBODIMENTS

A system according to one aspect of the invention is described below with reference to the figures. The circuits presented are simplified diagrams. Thus, different elements such as the boost means and calibration means are not represented in the figures. However, those skilled in the art understand that the figures are not limiting, and that the circuits may comprise such well-known elements. In particular, in the embodiments described, the member 10 is represented as a hydraulic motor intended to drive in rotation an element such as a wheel. However, the invention applies to other types of drive member, in particular translational drive members such as hydraulic jacks.

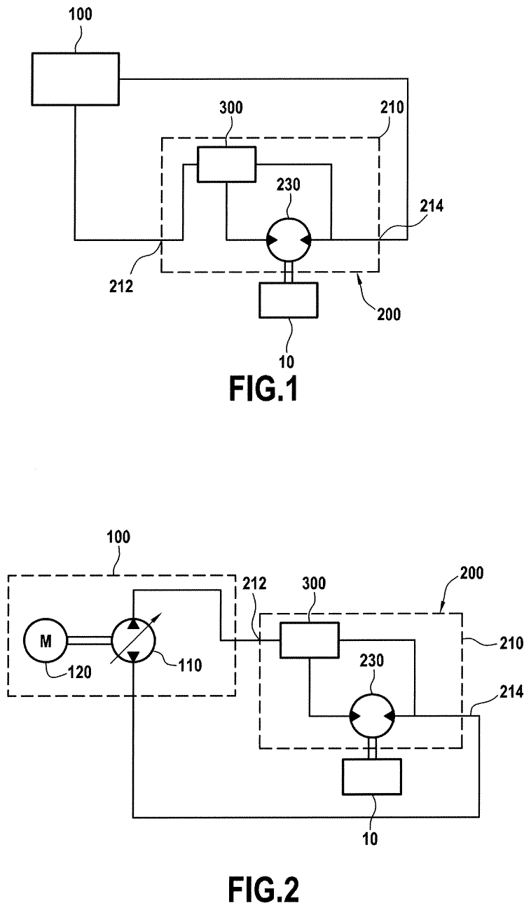

FIG. 1 is a general schematic view of a system according to one aspect of the invention. This figure represents a member 10, for example a member for moving a vehicle or machinery such as a wheel, a mechanical axle or an excavator turret ring. This member 10 is driven by a hydraulic circuit.

The hydraulic circuit as represented comprises a hydraulic energy source 100, for example a pressure source such as a pump or an accumulator, and a drive member 200. The hydraulic energy source 100 is adapted to supply the drive member 200, such that the drive member drives the member 10 in rotation or in translation depending on the type of member chosen. The circuit can be an open-loop or closed-loop circuit. In the case of an open-loop hydraulic circuit, the hydraulic energy source 100 typically comprises an ambient-pressure tank, a hydraulic pump or an accumulator and a valve or valve element ensuring the hydraulic connection depending on the operating mode.

It is understood that the system can be reversible. The description generally presents an operation in which the member 10 is driven in rotation. The hydraulic members having a reversible operation, a reverse operation is possible in particular during braking phases; the member 10 then performs a drive function allowing energy recovery.

The hydraulic energy source 100 is typically a hydraulic pump, for example a variable-displacement hydraulic pump 110 driven by a primary motor 120 such as a heat engine or an electric motor. The hydraulic energy source may also comprise a fixed-displacement hydraulic pump 110 and a primary motor 120 adapted to drive it in rotation at a variable speed. One exemplary embodiment (with a variable-displacement pump) is illustrated in FIG. 2.

The drive member 200 comprises a casing 210 in which is housed a primary hydraulic machine 230 typically adapted to have a motor operation in order to drive in rotation the member 10. The drive member also comprises a pressure booster 300 housed in the casing 210.

The pressure booster 300 is configured to selectively perform a pressure rise or amplification function. Thus for an initial pressure P1 at the intake of the pressure booster 300, the pressure booster 300 will deliver a pressure P2 such that P2>P1.

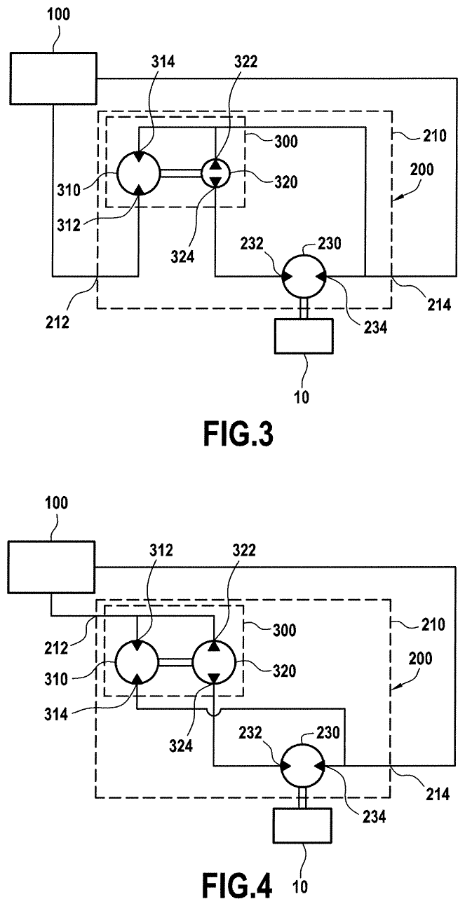

FIGS. 3 and 4 represent two exemplary embodiments of the pressure booster 300.

A first orifice 212 and a second orifice 214 which form a fluid intake and discharge according to the direction of circulation of the fluid, are defined for the casing 210. Similarly, a first orifice 232 and a second orifice 234 which form a fluid intake and discharge according to the direction of circulation of the fluid, are defined for the primary hydraulic machine 230. Within the framework of the description, for a motor operation of the primary hydraulic machine 230, it will be considered that the first orifice 212 forms a fluid intake, and therefore a high-pressure duct, and that the second orifice 212 forms a fluid discharge, and therefore a low-pressure duct. Unless otherwise stated, it will be considered that the operation described thus corresponds to an operation in traction and in forward gear.

The primary hydraulic machine 230 may for example be a rotating machine, typically a radial-piston and multilobe-came hydraulic machine, or an axial-piston hydraulic machine. The hydraulic machine may for example be used as a motor for driving a member such as a wheel or an axle, a hitch or a tool.

The primary hydraulic machine 230 may also be a jack, the two orifices 232 and 234 are then typically connected to two chambers of the jack for the application of opposing forces. In such a case, the system then typically comprises means adapted to limit the pressure in the hydraulic circuit, for example piloted calibration valve elements.

The pressure booster 300 typically comprises a first hydraulic machine 310 and a second hydraulic machine 320 that are secured in rotation, and configured such that one has a pump operation and the other has a motor operation, it being understood that such members are reversible and that a hydraulic motor can have a pump operation, and vice versa. In the examples illustrated, the first hydraulic machine 310 has a motor operation, and the second hydraulic machine 320 has a pump operation. By secured in rotation, it is meant here that the first hydraulic machine 310 and the second hydraulic machine 320 are coupled in rotation, and therefore rotate jointly. This rotational coupling can be achieved for example by coupling the two hydraulic machines on the same shaft, or by connecting them by a rigid mechanical link.

The first hydraulic machine 310 and the second hydraulic machine 320 are typically formed by the same hydraulic machine comprising two distinct parts.

In the example illustrated in FIG. 3, the first hydraulic machine 310 has a first orifice 312 and a second orifice 314, the first orifice 312 being connected to the first orifice 212 of the casing 210 (that is to say here to the orifice of the casing 210 having the highest pressure), and the second orifice 314 being connected to the second orifice 214 of the casing 210 (that is to say to the orifice of the casing 210 having the lowest pressure). The second hydraulic machine 320 has a first orifice 322 and a second orifice 324, the first orifice 322 being connected to the second orifice 314 of the first hydraulic machine 310 and to the second orifice 214 of the casing 210 (that is to say to the orifice of the casing 210 having the lowest pressure), and the second orifice 324 being connected to the first orifice 232 of the primary hydraulic machine 230, (that is to say its intake, and therefore its orifice having the highest pressure) via conduits arranged in the casing. In this embodiment, the first hydraulic machine 310 has a displacement C1 greater than the displacement C2 of the second hydraulic machine 320. Such an embodiment is referred to as a 3-line and common return booster. The first hydraulic machine 310 and/or the second hydraulic machine 320 may for example have fixed or variable displacements. For example, one may have a fixed displacement and the other may have a variable displacement, or both may have a fixed displacement, or both may have a variable displacement. The use of at least one variable-displacement hydraulic machine makes it possible to vary the pressure amplification or rise ratio by varying the displacement ratio between the first hydraulic machine 310 and the second hydraulic machine 320. The system can then, for example, comprise a controller adapted to pilot the variation of the displacement ratio and therefore the variation of the pressure rise ratio as a function of a setpoint or of operating conditions.

The first hydraulic machine 310 and the second hydraulic machine 320 are typically identical or similar in every respect and not symmetrical, where appropriate except for the displacement. The first hydraulic machine 310 and the second hydraulic machine 320 typically each have a single shaft output, these two shaft outputs being mechanically connected.

In operation, the pressure booster 300 is supplied by the hydraulic energy source 100. A high pressure is thus applied to the intake 312 of the first hydraulic machine 310. The latter performs a function of driving in rotation the second hydraulic machine 320. The second hydraulic machine is supplied by the discharge of the first hydraulic machine 310. However, due to the differences in the displacement, the second hydraulic machine 320 will then deliver a higher pressure, which is described as very high pressure, to supply the primary hydraulic machine 230. In this embodiment, the pressure rise therefore depends in particular on the ratio between the displacements C1 and C2.

More generally, the pressure booster 300 thus makes it possible to take a flow rate Q1 and a pressure P1 from an orifice of the casing 210, here the first orifice 212 of the casing 210, and to deliver a flow rate Q2 and a pressure P2 to the intake of the hydraulic machine 230 (here its first orifice 232), such that Q2<Q1 and P2>P1.

In the example illustrated in FIG. 4, the first orifice 312 of the first hydraulic machine 310 and the first orifice 322 of the second hydraulic machine 320 are both connected to the first orifice 212 of the casing 210 (that is to say here to the orifice of the casing 210 having the highest pressure).

The second orifice 314 of the first hydraulic machine 310 is connected to the second orifice 214 of the casing 210 (that is to say to the orifice of the casing 210 having the lowest pressure),

The second orifice 324 of the second hydraulic machine 320 is connected to the first orifice 232 of the primary hydraulic machine 230, (that is to say its intake, and therefore its orifice having the highest pressure) via conduits arranged in the casing. Such an embodiment is referred to as a 3-line and common supply booster.

In this embodiment, the first hydraulic machine 310 may typically have a displacement C1 equal or substantially equal to the displacement C2 of the second hydraulic machine 320.

In operation, the pressure booster 300 is supplied by the hydraulic energy source 100. A high pressure is thus applied to the intake 312 of the first hydraulic machine 310. The latter performs a function of driving in rotation the second hydraulic machine 320. The second hydraulic machine 320 is also supplied by the hydraulic energy source 100; it will therefore perform a pressure amplification function.

As for the previous embodiment, the pressure booster 300 thus makes it possible to take a flow rate Q1 and a pressure P1 from an orifice of the casing 210, here the first orifice 212 of the casing 210, and to deliver a flow rate Q2 and a pressure P2 to the intake of the hydraulic machine 230 (here its first orifice 232), such that Q2<Q1 and P2>P1.

More generally, the pressure booster 300 makes it possible to transform the high pressure at the intake of the casing 210 into a very high pressure at the intake of the primary hydraulic machine 230.

In the system according to the invention, as indicated above, the connection between the primary hydraulic machine 230 and the second hydraulic machine 320 is formed by conduits arranged in the casing 210 of the drive member 200. Such a structure thus makes it possible to confine the very high-pressure area to a reduced space internal to the casing 210, and to avoid a pressure rise in the entire circuit.

The proposed structure thus makes it possible to raise the pressure provided to the primary hydraulic machine 230, without requiring to oversize the various components of the hydraulic circuit.

This function can in particular be implemented on an ad hoc basis, for example for crossing an obstacle. The pressure booster 300 can then be selectively activated when conditions are met.

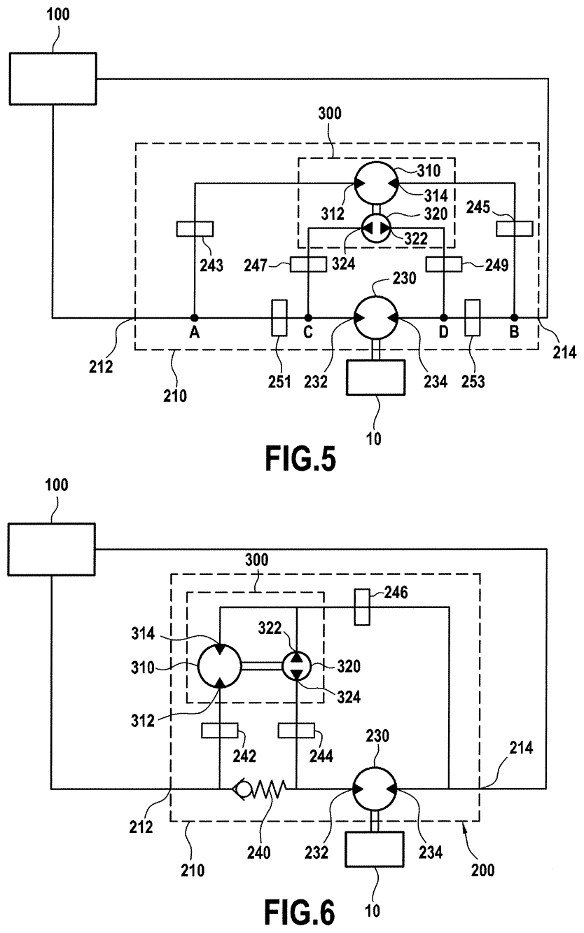

FIG. 5 schematically represents one variant of the invention in which the pressure booster 300 is made by a first hydraulic machine 310 and a second hydraulic machine 320 linked in rotation, in which the supply and discharge ducts of the first hydraulic machine 310 and the supply and discharge ducts of the second hydraulic machine 320 are, by default, isolated from each other. Such a pressure booster can be called “4-line booster” to be distinguished from the other variants of pressure boosters described which comprise “3 lines”; in particular, a distinction is made between the “3-line with common supply” booster as represented in FIG. 4 and the “3-line with common return” pressure booster as represented in FIGS. 3 and 6 to 9.

In the example illustrated in FIG. 5, valves allow the passage or non-passage of fluid in the conduits depending on the activation or non-activation of the pressure booster. This makes it possible to activate or not the pressure booster in one direction of rotation or in the other either in traction or in restraint (for example for machinery equipped with a system according to the invention).

The first hydraulic machine 310 has a first orifice 312 and a second orifice 314, the first orifice 312 is connected to the conduit joining the first orifice 212 of the casing 210 to the first orifice 232 of the primary hydraulic machine 230 at the level of a hydraulic junction A. The second orifice 314 is connected to the conduit joining the second orifice 214 of the casing 210 to the second orifice 234 of the primary hydraulic machine 230 at the level of a hydraulic junction B.

The second hydraulic machine 320 has a first orifice 322 and a second orifice 324, the first orifice 322 is connected to the conduit joining the second orifice 214 of the casing 210 to the second orifice 234 of the primary hydraulic machine 230 at the level of a hydraulic junction D. The second orifice 324 is connected to the conduit joining the first orifice 212 of the casing 210 to the first orifice 232 of the primary hydraulic machine 230 at the level of a hydraulic junction C.

A valve 243 is positioned between the first orifice 312 of the first hydraulic machine 310 and the hydraulic junction A.

A valve 245 is positioned between the second orifice 314 of the first hydraulic machine 310 and the hydraulic junction B.

A valve 247 is positioned between the second orifice 324 of the second hydraulic machine 320 and the hydraulic junction C.

A valve 249 is positioned between the first orifice 322 of the second hydraulic machine 320 and the hydraulic junction D.

A valve 251 is positioned on the conduit joining the first orifice 212 of the casing 210 to the first orifice 232 of the primary hydraulic machine 230 between the junction A and the junction C.

A valve 253 is positioned on the conduit joining the second orifice 214 of the casing 210 to the second orifice 234 of the primary hydraulic machine 230 between the junction D and the junction B.

Each of these valves 243, 245, 247, 249, 251 and 253 can be piloted to switch from a conductive state to a non-conductive state or from a non-conductive state to a conductive state. Thus, the valves 243, 245, 247, 249, 251 and 253 make it possible to isolate or not the first hydraulic machine 310 and/or the second hydraulic machine 320 from each other and either or both from the primary hydraulic machine 230.

It is noted that the system may have a smaller number of valves. Thus, the system comprises the valves 251 and 253, as well as at least one pair of valves among the pairs of valves 243 and 245 on the one hand, and 247 and 249 on the other hand.

These valves 243, 245, 247, 249, 251 and 253 may be hydraulically or electrically piloted from the inside or externally to the casing 210.

One example of operation in traction, in a direction of circulation that can be referred to as forward gear will now be described.

An initial situation is considered in which the pressure booster 300 is deactivated (for example by the user or the control unit of the system based on captured data). Thus, the valve 251 and the valve 253 are conductive. The valves 243, 245, 247 and 249 are non-conductive.

In this case, the first orifice 212 of the casing 210 is supplied by the pressure source 100 and therefore defines the high-pressure intake, while the second orifice 214 of the casing 210 defines the low-pressure discharge. The primary hydraulic machine 230 has a motor operation in traction mode without pressure rise. Moreover, the fluid does not circulate in the pressure booster 300.

When the pressure booster 300 is activated (for example by the user or by the control unit of the system based on captured data), the valves 251 and 253 are switched to the non-conductive configuration while the valves 243, 245, 247 and 249 are conductive.

As previously, the first orifice 212 of the casing 210 is then supplied by the pressure source 100 and therefore defines the high-pressure intake, while the second orifice 214 of the casing 210 defines the low-pressure discharge. However, in this case, the valve 251 being non-conductive, and the valve 243 being conductive, the high-pressure fluid goes towards the first orifice 312 of the first hydraulic machine 310 instead of going towards the first orifice 232 of the primary hydraulic machine 230. The second orifice 214 of the casing 210 being connected to the low pressure and the valve 253 being in a non-conductive configuration while the valve 245 is in a conductive configuration, the low pressure is established in the line going from the second orifice 214 of the casing 210 by passing through the hydraulic junction B and up to the second orifice 314 of the first hydraulic machine 310.

The pressure difference at the terminals of the first hydraulic machine 310 generates a rotational motion of this first hydraulic machine 310. The second hydraulic machine 320, being secured in rotation to the first hydraulic machine 310, will operate as a pump to generate a pressure difference at its terminals so as to generate a very high pressure (that is to say a pressure greater than the pressure provided by the pressure source to the first orifice 212 of the casing 210) in the hydraulic line going from the second orifice 324 of the second hydraulic machine 320 to the first orifice 232 of the primary hydraulic machine 230, the valve 247 being in a conductive state. In the hydraulic line going from the first orifice 322 of the second hydraulic machine 320 to the second orifice 234 of the primary hydraulic machine 230, the low pressure has been established, the valve 249 on this line being in a conductive state.

The pressure difference at the terminals of the primary hydraulic machine 230 being greater than when the pressure booster is deactivated, the member 10 rotated by the primary hydraulic machine 230 can exert a greater torque (for example to allow the machinery equipped with such a device to cross an obstacle).

One example of operation in restraint in the same direction of circulation as previously described, which can be referred to as forward gear, will now be described.

When the pressure booster 300 is deactivated (for example by the user or the control unit of the system based on captured data), the valve 251 and the valve 253 are conductive. The valves 243, 245, 247 and 249 are non-conductive.

In this case, the machine being in a restraint mode (for example what is called hydrostatic braking) although the machine is in forward gear (for example driven by its inertia), the hydraulic circuit aims to create a resisting torque opposite to the direction of rotation of the member 10. In this case, the second orifice 214 of the casing 210 is at high pressure, while the first orifice 212 of the casing 210 is at low pressure. Due to the restraint, the primary hydraulic machine 230 has a pump operation without pressure rise due to the pressure booster 300, in which the fluid does not circulate.

When the pressure booster 300 is activated (for example by the user or the control unit of the system based on the captured data), the valves 251 and 253 are non-conductive while the valves 243, 245, 247 and 249 are conductive.

The primary hydraulic machine 230 has in restraint a pump operation and a very high pressure is established on the line connecting the second orifice 234 of the primary hydraulic machine 230 to the first orifice 322 of the second hydraulic machine 320, the valve 249 being conductive and the valve 253 being in a non-conductive state. The line connecting the first orifice 232 of the primary hydraulic machine 230 to the second orifice 324 of the second hydraulic machine 320 is at low pressure (the valve 247 being in a conductive state). The pressure difference at the terminals of the second machine 320 generates its motor operation. The second machine 320, which is secured in rotation to the first hydraulic machine 310, causes the latter to work as a pump in order to exert the restraint of the machinery equipped with a system according to the invention by the establishment of a high pressure in the line going from the second orifice 314 of the machine 310, by passing through the valve 245 which is in a conductive state, through the hydraulic junction B, by the second orifice 214 of the casing 210 (the valve 253 being in a non-conductive state) to join the pressure source 100. The line going from the first orifice 312 of the first hydraulic machine 310 passing through the valve 243 (which is in a conductive state), through the hydraulic junction A, by the first orifice 212 of the casing 210 and joining the pressure source 100 being at low pressure.

The system is reversible, and has a similar operation in a reversed direction typically corresponding to an operation in reverse gear, whether in traction or in restraint, with the pressure booster 300 engaged or not.

The embodiment presented is in particular advantageous due to its structural symmetry which makes it possible to operate indifferently with the pressure booster 300 according to the invention engaged or disengaged in restraint and in traction in forward gear and reverse gear.

FIG. 6 schematically represents one variant of FIG. 3 to which actuators such as valves have been added to pilot the activation or non-activation of the pressure booster 300. As in FIG. 3, this is a 3-line and common return booster.

In this figure, the first orifice 232 of the primary hydraulic machine 230 is connected to the first orifice 212 of the casing 210 via a calibrated valve element 240, which is conductive in the direction of the first orifice 212 of the casing 210 towards the first orifice 232 of the primary hydraulic machine 230 when the pressure at the first orifice 212 of the casing 210 exceeds a calibration value.

It should be noted that the calibrated valve element 240 can also be a piloted calibrated valve element, that is to say a valve element whose opening can be controlled by an external command, for example a hydraulic or pneumatic command.

This figure also represents different possible locations for a pilot valve for piloting the activation or non-activation of the pressure booster 300. It is understood that the different locations indicated can be used individually or combined in the same embodiment depending on the desired piloting.

According to a first example, the system comprises a valve 242 positioned between the first orifice 212 of the casing 210 and the first orifice 312 of the first hydraulic machine 310, that is to say upstream of the intake of the hydraulic motor of the pressure booster according to the operation considered. Thus, when the valve 242 is non-conductive, the pressure booster 300 is not supplied and is therefore disengaged. By disengaged, it is meant here that the pressure booster 300 is not operational, that is to say in particular that the pressure difference between the two orifices 232 and 234 of the primary hydraulic machine 230 is equal to the pressure difference between the two orifices 212 and 214 of the casing 210, excluding head losses.

According to a second example, the system comprises a valve 244 positioned between the second orifice 324 of the second hydraulic machine 320 and the first orifice 232 of the primary hydraulic machine 230. When the valve 244 is non-conductive, the discharge of the second hydraulic machine 320 is sealed, the first hydraulic machine 310 and the second hydraulic machine 320 then have zero effective displacement.

According to a third example, the system comprises a valve 246 positioned between the second orifice 314 of the first hydraulic machine 310 and the first orifice 322 of the second hydraulic machine 320 on the one hand, and the second orifice of the casing 214 and the second orifice 234 of the primary hydraulic machine 230 on the other hand. This valve 246 is then typically used in conjunction with one of the valves 242 and/or 244 described above. The valve 246 is then conductive when the pressure booster 300 is engaged. The valve 246 and, where applicable, either or both of the valves 242 and/or 244 is non-conductive when the pressure booster 300 is disengaged.

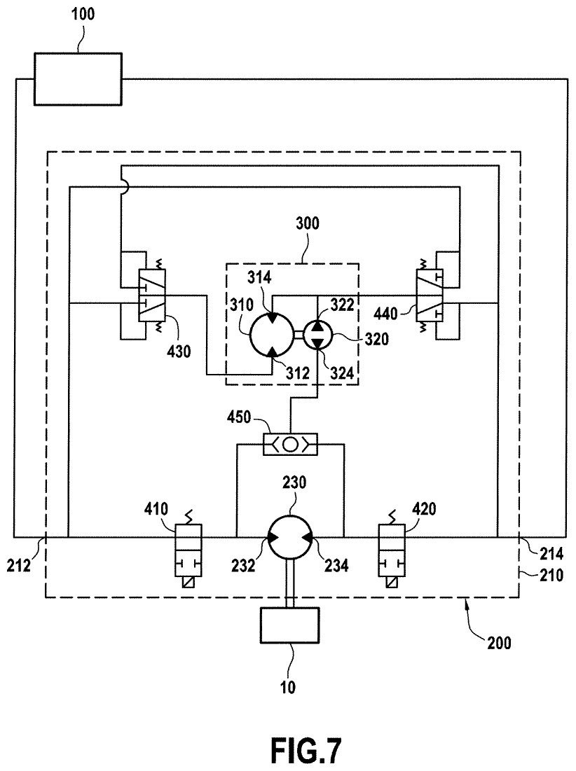

FIG. 7 shows one exemplary embodiment of a system according to one aspect of the invention. This figure represents the different elements allowing an operation of the system in both directions of rotation of the primary hydraulic machine 230, whether in traction mode or in restraint mode. The particularity and interest of such a circuit is that it makes it possible to offer the user an operation called 4-quadrant operation with a pressure booster that does not have a symmetrical pattern. In this exemplary embodiment, the pressure booster 300 is a 3-line and common return type similar to the one already described with reference to FIG. 3.

In the illustrated example, different pilot valves are integrated so as to pilot the commissioning or non-commissioning of the pressure booster 300. These different pilot valves that are described below may or may not be integrated into the casing 210.

The pilot valves may for example be configured so as to commission the pressure booster when the pressure difference between the first orifice 212 and the second orifice 214 of the casing 210 exceeds a threshold value, and to disengage it when the pressure difference between the first orifice 212 and the second orifice 214 of the casing 210 is below said threshold value. Such a type of engagement corresponds for example to an obstacle crossing. As a variant, the pilot valves may for example be configured so as to disengage the pressure booster when a fluid flow rate at the orifice of the casing 210 forming the fluid intake exceeds a flow rate threshold value, which reflects a movement at high speed. Alternatively or in addition, the system may comprise a sensor of the rotational speed of the member 10 or of an axle driven by the primary hydraulic machine 230 associated with a controller such as an electronic control unit or ECU (according to the acronym commonly used) such that the pilot valves are then piloted to disengage the pressure booster when the speed measured by the sensor exceeds a certain threshold.

The system as presented comprises two circuit-breaker valves 410 and 420, which are designated by first circuit-breaker valve 410 and second circuit-breaker valve 420. These valves are typically on/off type valves, which may be conductive or non-conductive. For example, they may be solenoid valves which are conductive by default, that is to say in the absence of piloting, or which are non-conductive by default.

The first circuit breaker valve 410 is positioned between the first orifice 212 of the casing 210 and the first orifice 232 of the primary hydraulic machine 230. The second circuit breaker valve 420 is positioned between the second orifice 214 of the casing 210 and the second orifice 234 of the primary hydraulic machine 230.

The system also comprises two calibrated valves or amplification valves, respectively 430 and 440. In the illustrated example, these valves 430 and 440 are independent. As a variant, these valves 430 and 440 may be mechanically linked.

The first amplification valve 430 is typically a slide valve, adapted to selectively connect the first orifice 312 of the first hydraulic machine 310 either to the first orifice 212 of the casing 210, or to the second orifice 214 of the casing 210, typically to that of said orifices 212 and 214 having the highest pressure.

The first amplification valve 430 is by default in a non-conductive configuration.

It has a calibration, such that it is only conductive when the pressure difference between the first orifice 212 of the casing 210 and the second orifice 214 of the casing 210 exceeds a calibration value or engagement value.

The second amplification valve 440 is typically a slide valve, adapted to selectively connect the second orifice 314 of the first hydraulic machine 310 and the first orifice 322 of the second hydraulic machine 320 either to the first orifice 212 of the casing 210, or to the second orifice 214 of the casing 210, typically to that of said orifices 212 and 214 having the lowest pressure. The second amplification valve 440 is by default in a non-conductive configuration. It has a calibration, such that it is only conductive when the pressure difference between the first orifice 212 of the casing 210 and the second orifice 214 of the casing 210 exceeds said calibration value or engagement value.

The second orifice 324 of the second hydraulic machine 320 is connected to the first orifice 232 and to the second orifice 234 of the primary hydraulic machine 230 by a high-pressure selector 450, adapted to connect the second orifice 324 of the second hydraulic machine 320 to the orifice of the primary machine 230 having the highest pressure.

This structure of the system allows for a reversible operation, as described below.

A first operating mode of the system is described, corresponding to a traction mode along a first direction of circulation that can be referred to as forward gear. In this embodiment, the first orifice 212 of the casing 210 is supplied by the hydraulic energy source 100 and therefore defines the high-pressure intake, while the second orifice 214 of the casing 210 defines the low-pressure discharge. The primary hydraulic machine 230 has a motor operation. The circuit-breaker valves 410 and 420 are conductive; the primary hydraulic machine 230 is therefore supplied directly by the hydraulic energy source 100. When the pressure difference between the first orifice 212 of the casing 210 and the second orifice 214 of the casing 210 is smaller than the calibration value or engagement value, the pressure booster 300 is disengaged.

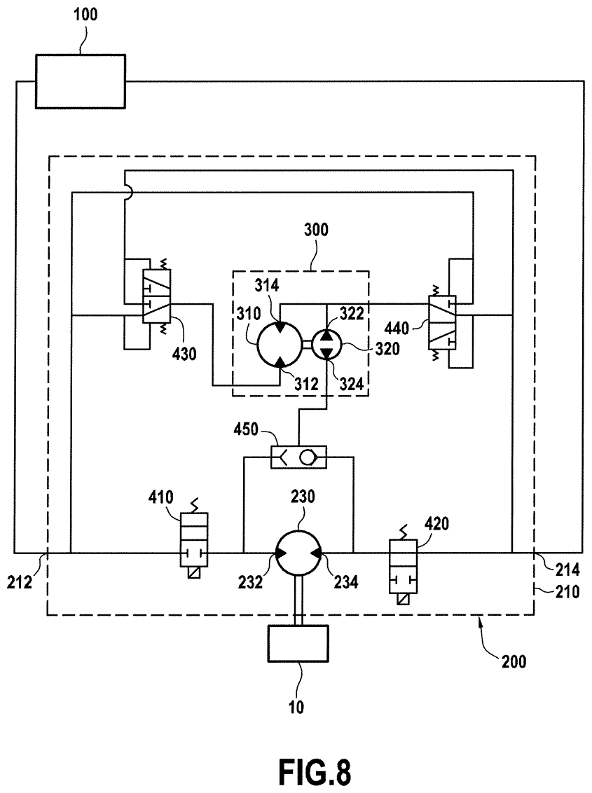

When the pressure difference between the first orifice 212 of the casing 210 and the second orifice 214 of the casing 210 exceeds the calibration value, the amplification valves 430 and 440 are actuated. The first orifice 312 of the first hydraulic machine 310 is then connected to the first orifice 212 of the casing 210, while the second orifice 314 of the first hydraulic machine 310 and the first orifice 322 of the second hydraulic machine 320 are connected to the second orifice 214 of the casing 210. The circuit breaker valve 410 is then switched so that it is no longer conductive. This configuration is represented in FIG. 8.

In this configuration, the operation presented with reference to FIG. 3 is then found; the high-pressure selector 450 ensures that the pressure delivered by the second hydraulic machine 320 is delivered to the intake of the primary hydraulic machine 230, that is to say here its first orifice 232. The pressure P2 is isolated from the hydraulic circuit due to the switching of the circuit breaker valve 410 to its non-conductive configuration.

The circuit breaker valves 410 and 420 are then piloted to switch to their conductive configuration when the pressure difference between the first orifice 212 of the casing 210 and the second orifice 214 of the casing 210 falls below the calibration value or engagement value, or for example when the flow rate at the first orifice 212 of the casing 210 or at the second orifice 214 of the casing 210 exceeds a threshold value, or when the rotational speed of the primary hydraulic machine 230 exceeds a threshold value, which disengages the pressure booster 300.

In an operating situation in the same direction but in the event of braking or restraint, the high-pressure and low-pressure branches of the hydraulic circuit are reversed.

The high-pressure branch of the circuit is established at the second orifice 234 of the primary hydraulic machine 230, which is therefore connected to the second orifice 324 of the second hydraulic machine 320 via the high-pressure selector 450.

If the pressure difference between the first orifice 212 of the casing 210 and the second orifice 214 of the casing 210 is smaller than the calibration value or engagement value, the amplification valves 430 and 440 are non-conductive, and the pressure booster is disengaged.

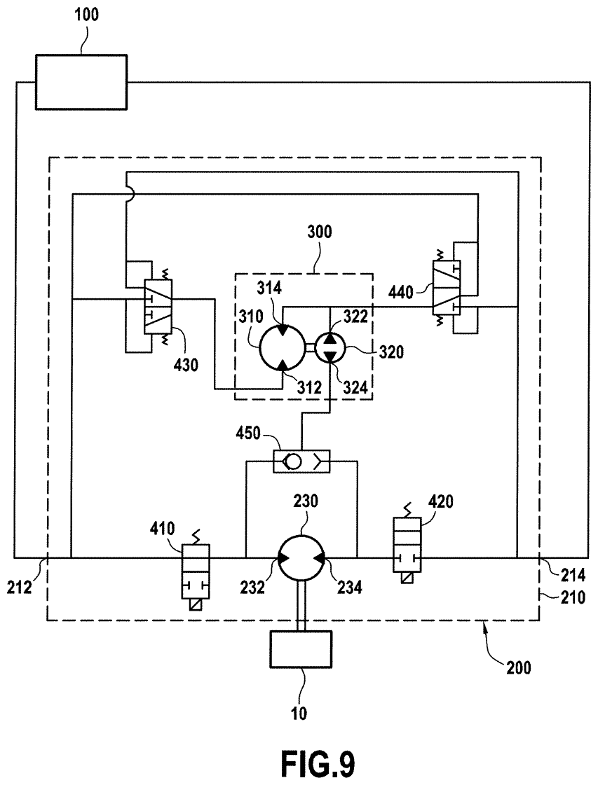

If the pressure difference between the first orifice 212 of the casing 210 and the second orifice 214 of the casing 210 is greater than or equal to the calibration value or engagement value, the amplification valves 430 and 440 are conductive. The first orifice 312 of the first hydraulic machine 310 is then connected to the second orifice 214 of the casing 210, while the second orifice 314 of the first hydraulic machine 310 and the first orifice 322 of the second hydraulic machine 320 are connected to the first orifice 212 of the casing 210. The circuit breaker valve 420 is then switched so that it is no longer conductive. This configuration is represented in FIG. 9.

In this operation, the first hydraulic machine 310 is supplied by the pressure P1 at the second orifice 214 of the casing 210. It drives the second hydraulic machine 320, which delivers a pressure P2 such that P2>P1 at its second orifice 324 due to the ratio between the displacements of these two hydraulic machines 310 and 320. This pressure P2 is applied to the second orifice 234 of the primary hydraulic machine 230, which accentuates the restraining effect. This pressure P2 is isolated from the rest of the hydraulic circuit due to the switching of the circuit-breaker valve 420 to its non-conductive configuration.

The system as presented is fully reversible, and can therefore also operate in the opposite direction for example a driving in reverse gear, whether in traction or in restraint, with or without engagement of the pressure booster 300.

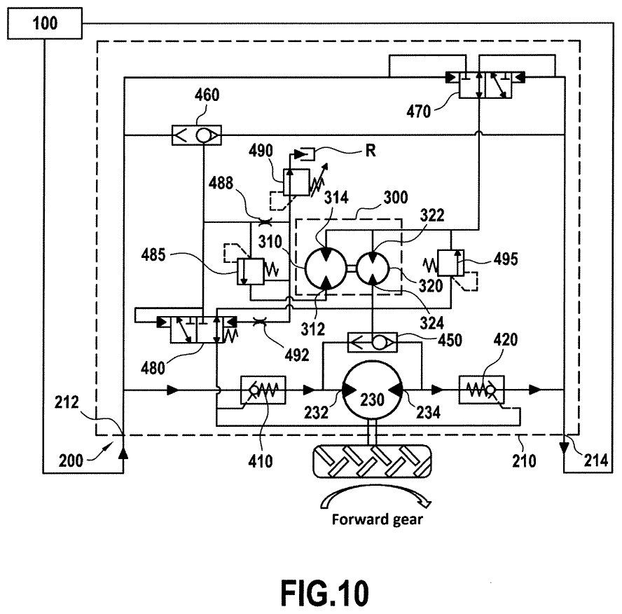

FIG. 10 shows another example of a system according to one aspect of the invention.

In this embodiment, the pressure booster 300 is associated with a plurality of valves and members making it possible to ensure automatic commissioning of the pressure booster 300 when the pressure in the hydraulic circuit exceeds a pressure threshold value.

In this embodiment, the pressure booster 300 has a structure similar to the one already described with reference in particular to FIG. 3.

In this embodiment, the valves 410 and 420 (presented previously in FIGS. 7, 8 and 9) are replaced by calibrated non-return flaps with piloted chambers.

The first orifice 212 and the second orifice 214 of the casing 210 are connected in parallel to a high-pressure selector 460 and to a low-pressure selector 470.

The low-pressure selector 470 is connected to the second orifice 314 of the first hydraulic machine 310 and to the first orifice 322 of the second hydraulic machine 320.

The high-pressure selector 460 is connected to a pilot valve 480, as well as to a sequence valve element 485 and to a first restriction 488. The first restriction 488 is connected to a relief valve element 490 adapted to perform a relief when the pressure exceeds a relief threshold value, and is also connected to a hydraulic pilot line of the sequence valve element 485, as well as to a hydraulic pilot line of the pilot valve 480 via a second restriction 492.

The sequence valve element 485 connects the high-pressure selector 460 to the first orifice 312 of the first hydraulic machine 310 of the pressure booster 300.

The pilot valve 480 is connected on the one hand to the piloted chambers of the calibrated non-return flaps 410 and 420, and on the other hand to the second orifice 324 of the second hydraulic machine 320.

The second orifice 324 of the second hydraulic machine 320 is also connected to the high-pressure selector 450 and to a pressure limiter 495. The high-pressure selector 450 is connected to the two orifices 232 and 234 of the primary hydraulic machine 230. It is adapted to connect the second orifice 324 of the second hydraulic machine 320 to the orifice of the primary machine 230 having the highest pressure.

The pilot valve 480 is configured to selectively connect the piloted chambers of the calibrated non-return flaps 410 and 420 either to the high-pressure selector 460 or to the high-pressure selector 450 connected to the second orifice 324 of the second hydraulic machine 320. By default, the pilot valve 480 connects the piloted chambers of the calibrated non-return flaps 410 and 420 to the second orifice 324 of the second hydraulic machine 320. When the pressure at the level of the high-pressure selector 460 exceeds by a certain threshold (determined by the stiffness of the elastic return means of the pilot valve 480) the value of the pressure at the level of the second restriction 492 on the side of the pilot chamber 480, the latter switches to its configuration in which it connects the piloted chambers of the calibrated non-return flaps 410 and 420 to the high-pressure selector 460.

The sequence valve element 485 is by default non-conductive. It becomes conductive when the difference between the pressure at its intake and the pressure delivered to its pilot line at the outlet of the first restriction 488 exceeds a sequence threshold value. This sequence threshold value is reached when the relief valve element 490 becomes conductive (because then a flow rate passes in the first restriction 488 thus creating a pressure difference at its terminals, the lowest pressure being at the terminal connected to the relief valve element 490). The relief valve element 490 thus determines by its calibration (typically by means of a calibrated spring) the pressure value from which the sequence valve element is engaged, and thus the pressure value from which the pressure booster 300 is supplied. The calibration of the relief valve element 490 can be adjustable or fixed.

A first operating mode of this system, corresponding to an operating mode in a first direction of operation, without pressure rise, is now described. This operating mode corresponds to the configuration shown in FIG. 10.

The hydraulic energy source 100 delivers a supply pressure P1 to the first orifice 212 of the casing 210.

The high-pressure selector 460 then connects the pilot valve 480, the first restriction 488 and the sequence valve element 485 to the first orifice 212 of the casing 210. The low-pressure selector 470 connects the second orifice 314 of the first hydraulic machine 310 and the first orifice 322 of the second hydraulic machine 320 to the second orifice 214 of the casing 210.

The pressure P1 as considered here is lower than the calibration pressure of the relief valve element 490. The sequence valve element 485 is in its non-conductive configuration.

The pilot valve 480 is in its default configuration. It connects the piloted chambers of the calibrated non-return flaps 410 and 420 to the second orifice 324 of the second hydraulic machine 320, to the pressure limiter 495 and to the high-pressure selector 450.

The pressure booster 300 is thus not put into operation.

The pressure P1 delivered by the pressure source 100 supplies the primary hydraulic machine 230 via its first orifice 232. In addition, the pressure P1 pilots the piloted chambers of the calibrated non-return flaps 410 and 420 via the high-pressure selector 450. The calibrated non-return flap 420 is thus conductive, so as to allow the discharge of the primary hydraulic machine 230 towards the second orifice 214 of the casing 210.

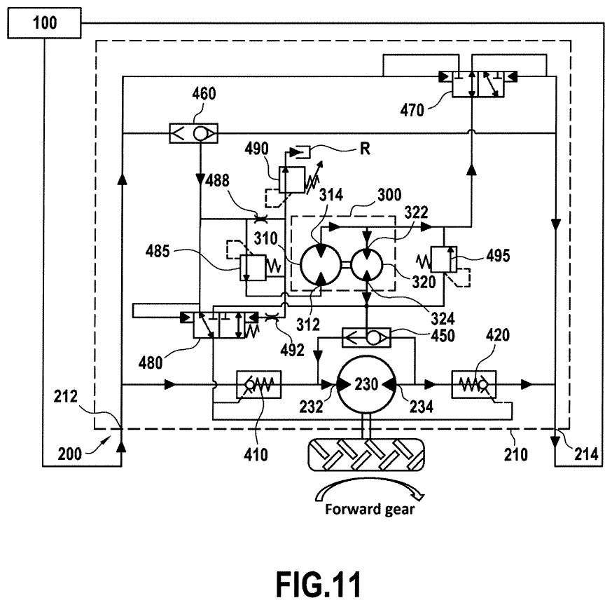

FIG. 11A now describes a second operating mode of this system, corresponding to an operating mode in a first operating direction, with pressure rise. The differences with the first operating mode are described below.

In this second operating mode, the hydraulic energy source 100 delivers a pressure P1, greater than the calibration pressure of the relief valve element 490.

The relief valve element 490 is thus conductive, and relieves the excess pressure into the tank R, a fluid flow rate therefore passes in this valve element 490. This fluid flow rate generates a head loss in the first restriction 488 and therefore a pressure difference at its terminals (the lowest pressure being at the level of the relief valve element 490).

The sequence valve element 485 then switches to its conductive configuration when the difference between the pressure at its intake and its pilot pressure exceeds the calibration value applied by a return element, typically of the order of a few bars, for example 4 bars.

Similarly, the pilot valve 480 switches to its configuration in which it connects the piloted chambers of the calibrated non-return flaps 410 and 420 to the high-pressure selector 460 when the pressure difference between the pressure P1 delivered by the hydraulic energy source 100 and the pilot pressure at the level of the second restriction 492 exceeds a calibration value applied by the elastic return means to the pilot valve 480, typically of the order of a few bars, for example 4 bars.

The pressure booster 300 is supplied via the first orifice 312 of the first hydraulic machine 310. The latter operates as a motor, and drives in rotation the second hydraulic machine 320 whose intake 322 is connected to the discharge 314 of the first hydraulic machine 310. As already described above, due to the ratio between the displacements C1 and C2 of the first hydraulic machine 310 and of the second hydraulic machine 320, the pressure delivered by the second hydraulic machine 320 to its second orifice 324 is a pressure P2 such that P2>P1. The pressure limiter 495 defines a maximum pressure P2max, beyond which the excess pressure is returned to the return line of the hydraulic circuit.

The pressure P2 supplies the primary hydraulic machine 230 via the high-pressure selector 450. The latter is in the configuration connecting the second orifice 324 of the second hydraulic machine 320 to the first orifice 232 of the primary hydraulic machine 230 due to the pressure rise, as described above.

The calibrated non-return flap 410 is non-conductive, its piloted chamber being at the pressure P1 while the pressure P2 is applied to the first orifice 232 of the primary hydraulic machine 230.

The primary hydraulic machine 230 discharges the flow rate that supplies it via its second orifice 234 to the second orifice 214, this flow rate passing through the calibrated non-return flap 420 which is itself conductive due to the pressure P1 applied to its piloted chamber.

It is therefore understood here that when the pressure delivered by the hydraulic energy source 100 exceeds a pressure threshold value, the proposed system automatically switches to an operating mode commissioning the pressure booster 300.

When the pressure delivered by the hydraulic energy source 100 decreases and falls below said pressure threshold value, the system switches to its first operating mode as described above.

The system as presented is reversible. Thus, the two operating modes described with reference to FIGS. 10 and 11 can also be applied for an operation in the opposite direction, the high-pressure selector 450, the high-pressure selector 460 and the low-pressure selector 470 allow a reversal of the system while maintaining an unchanged operating principle.

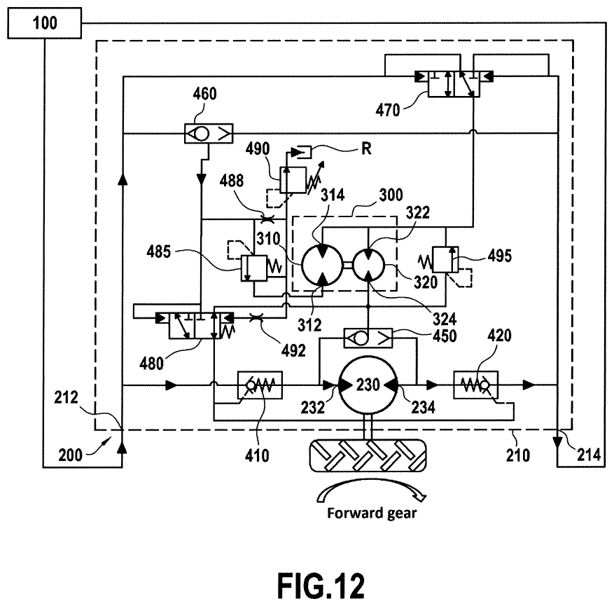

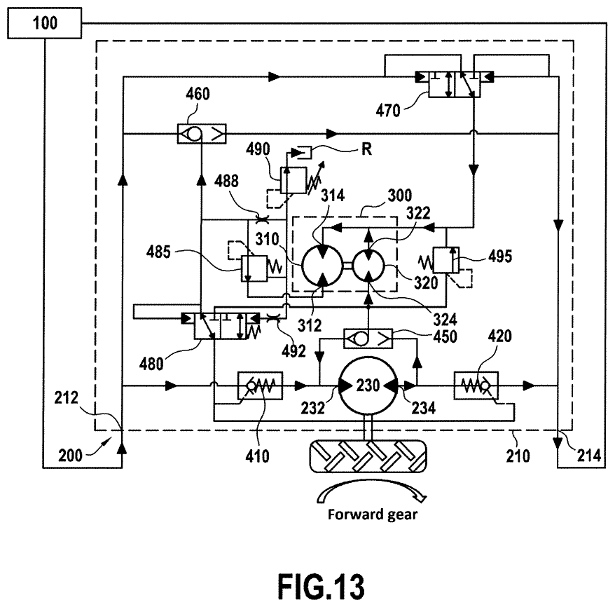

The system as proposed also allows an operation in hydrostatic braking or in restraint. Such operation is represented in FIGS. 12 and 13, respectively showing the cases in which the pressure booster 300 is not engaged, and in which the pressure booster 300 is engaged.

FIG. 12 shows a configuration similar to the one already described with reference to FIG. 10, but in which the high-pressure and low-pressure branches of the hydraulic circuit are reversed. In an operation in restraint or in braking, the primary hydraulic machine 230 has a pump operation; its intake orifice 232 is at low pressure, while its discharge orifice 234 is at high pressure. Similarly, the first orifice 212 of the casing 210 is at a low pressure, and the second orifice 214 of the casing 214 is at high pressure. The operation of the system compared to the one already described with reference to FIG. 10 remains unchanged. The high-pressure selector 450, the high-pressure selector 460 and the low-pressure selector 470 ensure a reversal of the hydraulic connections to maintain an operation as already described with reference to FIG. 10.

More specifically, in this operating mode, the hydraulic energy source 100 no longer delivers power. The primary hydraulic machine 230 performs a hydraulic pump function. It delivers a pressurized flow rate which is applied to the piloted chambers of the calibrated non-return flaps 410 and 420 via the high-pressure selector 450 so that they are conductive.

The high-pressure selector 460 and the low-pressure selector 470 ensure that the high-pressure line is connected in particular to the first restriction 488. As long as the pressure remains below the calibration pressure of the relief valve element 490, the pressure booster 300 is disengaged as already described with reference to FIG. 10.

FIG. 13 shows a configuration for an operation in restraint with the pressure booster 300 in service. As already described with reference to FIG. 11, the pressure booster is commissioned as soon as the pressure at the level of the relief valve element 490 exceeds its calibration pressure, and the difference between the pressure at the intake of the sequence valve element 485 and the pressure between the first restriction 488 and the second restriction 492 exceeds the calibration value defined by the elastic return means of the sequence valve element 485.

The sequence valve element 485 then becomes conductive, which allows the rotation of the first hydraulic machine 310 and of the second hydraulic machine 320 of the pressure booster 300 by allowing a circulation of the fluid at the first orifice 312 of the first hydraulic machine 310. The valve 480 changes position to connect the highest system pressure P1 to the pilot chamber of the piloted flaps 410 and 420.

Transiently, the first hydraulic machine 310 is driven in rotation by sucking oil from its orifice 312 and by discharging this oil to the orifice 314. The latter, in motor operation, drives in rotation the second hydraulic machine 320, which begins to operate as a pump discharging its oil to the orifice 324. This discharge causes the pressure rise at the level of the second orifice 234, the conduit at the level of this orifice seeing the two hydraulic machines 230 and 320 discharging towards it in pump mode. The flap 420 whose pilot chamber has been set to the highest system pressure P1 by means of the high-pressure selector 460, closes and becomes non-conductive. The flap 410 is maintained in its conductive position thanks to the pilot chamber connected to the pressure P1.

Due to the closure of the flap 420, the second hydraulic machine 320 is then supplied via its second orifice 324 by the pressure delivered by the primary hydraulic machine 230. It drives in rotation the first hydraulic machine 310 which, due to its higher displacement, performs an additional braking function. This braking will cause a pressure rise at the second orifice 324 of the second hydraulic machine 320 (which here forms its intake), and therefore at the second orifice 234 of the primary hydraulic machine 230 (which here forms its discharge), which amplifies the pressure difference at the terminals of the primary hydraulic machine 230 and therefore the braking or restraining effect.

The fluid delivered by the first hydraulic machine 310 is then routed via the high-pressure selector 460 to the second orifice 214 of the casing 210.

The operation in traction or in restraint thus makes it possible to automatically engage the pressure booster 300 as soon as the pressure difference at the terminals of the primary hydraulic machine 230 exceeds a threshold value.

As for the operation in traction, it is understood that the operation in braking or in restraint is reversible. Thus, the two operating modes described with reference to FIGS. 12 and 13 can also be applied for an operation in the opposite direction, the high-pressure selector 450, the high-pressure selector 460 and the low-pressure selector 470 allow a reversal of the system while maintaining an unchanged operating principle.

As a variant, the relief valve element 490 can be an electrically piloted valve. The calibration of the relief valve element 490 can thus be monitored and modified, and the opening of the relief valve element 490 can be piloted. As a variant, it can be chosen that the calibration of the relief valve element 490 can be adjustable by a hydraulic or mechanical action.

As a variant, the relief valve element 490 may be connected at its outlet with a 2-position, 2-orifice distributor which makes it possible to obstruct the link to a low-pressure enclosure (casing or tank) and prevent any activation of the pressure booster 300 when this link is cut.

As a variant, a 2-position, 2-orifice distributor may be mounted in parallel with the relief valve element 490, so as to make it possible to force the commissioning of the pressure booster 300 by forcing a leak.

As described above, the opening of the relief valve element 490 pilots the commissioning of the pressure booster 300. Thus, the piloting of the relief valve element 490, for example using an electrical command, makes it possible to pilot the commissioning of the pressure booster 300.

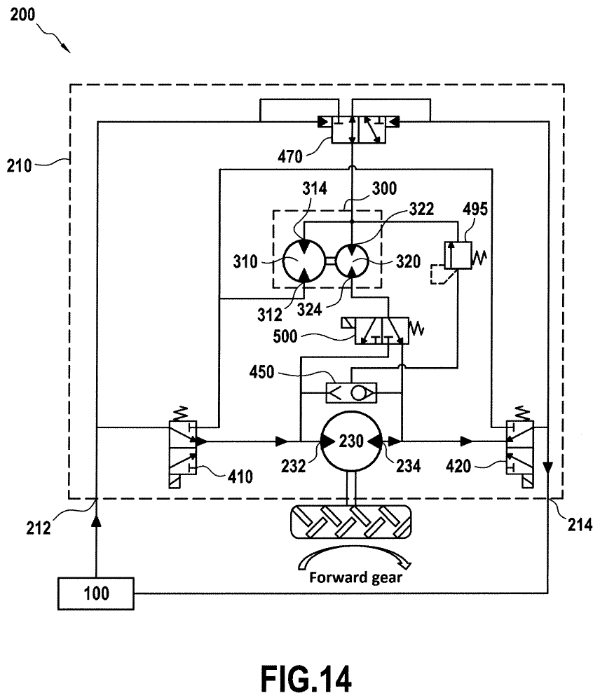

FIG. 14 shows another exemplary embodiment of a system according to one aspect of the invention.

Unlike the variant described above with reference to FIGS. 10 to 13, this variant is a variant piloted, for example using electrical commands or actuators. Thus, the commissioning or non-commissioning of the pressure booster 300 can here be chosen by a user or via a controller.

In this embodiment, the valves 410 and 420 which are here for example solenoid valves are found. It is understood that this embodiment is not limiting, and that the valves presented as solenoid valves, in particular the valves 410, 420 and/or 500, can be hydraulically piloted valves, typically displacement slides.

The orifices 212 and 214 of the casing 210 are each connected on the one hand to the low-pressure selector 470, and on the other hand respectively to one of the valves 410 and 420.

The valve 410 makes it possible to connect the first orifice 212 of the casing 210 as well as the low-pressure selector 470 either to the first orifice 232 of the primary hydraulic machine 230, or to the first orifice 312 of the first hydraulic machine 310 of the pressure booster 300. In its default configuration, the valve 410 connects the first orifice 212 of the casing 210 to the first orifice 232 of the primary hydraulic machine 230.

The valve 420 makes it possible to connect the second orifice 214 of the casing 210 as well as the low-pressure selector 470 either to the second orifice 234 of the primary hydraulic machine 230 or to the first orifice 312 of the first hydraulic machine 310 of the pressure booster 300. In its default configuration, the valve 420 connects the second orifice 214 of the casing 210 to the second orifice 234 of the primary hydraulic machine 230.

The low-pressure selector 470 connects the pressure booster 300, particularly the second orifice 314 of the first hydraulic machine 310 and the first orifice 322 of the second hydraulic machine 320 to the orifice among the first orifice of the casing 212 and the second orifice of the casing 214 having the lowest pressure. The low-pressure selector 470 is also connected to a pressure limiter 495 adapted to perform a pressure limiting function in the circuit. The two orifices 232 and 234 of the primary hydraulic machine 230 are connected to the pressure limiter 495 via a high-pressure selector 450 which ensures a safety function in the very high-pressure branch.

A selection slide 500 connects the second orifice 324 of the second hydraulic machine 320 either to the first orifice 232 or to the second orifice 234 of the primary hydraulic machine 230, which thus makes it possible to select the terminal of the primary hydraulic machine 230 whose pressure is to be raised.

A first operating mode is now described with reference to FIG. 14, corresponding for example to an operation in traction in forward gear, without commissioning the pressure booster 300.

The hydraulic energy source 100 delivers a supply pressure P1 to the first orifice 212 of the casing 210.

The valve 410 and the valve 420 are in their default configuration. The pressure P1 thus supplies the first orifice 232 of the primary hydraulic machine 230. The fluid at the discharge 234 of the primary hydraulic machine 230 passes through the valve 420 to reach the second orifice 214 of the casing 210.

The pressure booster 300 is connected to the second orifice 214 of the casing 210 and is not supplied. The primary hydraulic machine 230 is thus supplied directly by the hydraulic energy source 100.

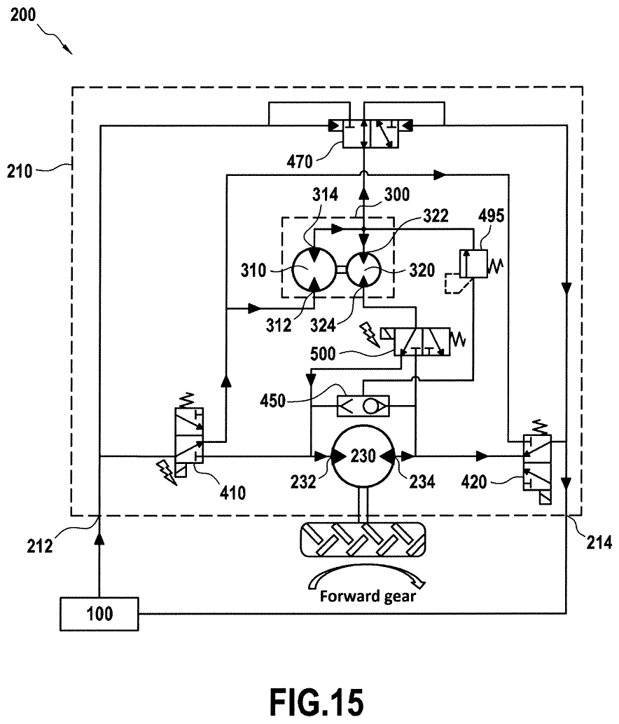

A second operating mode is now described with reference to FIG. 15, corresponding for example to an operation in traction in forward gear, with commissioning of the pressure booster 300.

In this operating mode, the command of the valve 410 is actuated. The pressure P1 delivered by the hydraulic energy source 100 thus supplies the first orifice 312 of the first hydraulic machine 310. The latter has a motor operation, and drives in rotation the second hydraulic machine 320. The latter is supplied via the discharge of the first hydraulic machine 320, and due to the ratio between the displacements, can deliver a pressure P2>P1.

The pressure P2 is applied to the first orifice 232 of the primary hydraulic machine 230 via the selection slide 500 whose command is actuated. The discharge of the primary hydraulic machine 230 passes through its second orifice 234, and via the valve 420. The excess fluid derived from the second orifice 314 of the first hydraulic machine 310 of the pressure booster 300 in the circuit passes through the low-pressure selector 470 to reach the second orifice 214 of the casing 210.

It is thus understood that the engagement of the pressure booster is done by the activation of the valve 410. Conversely, the pressure booster 300 can be disengaged by ceasing to pilot the valve 410.

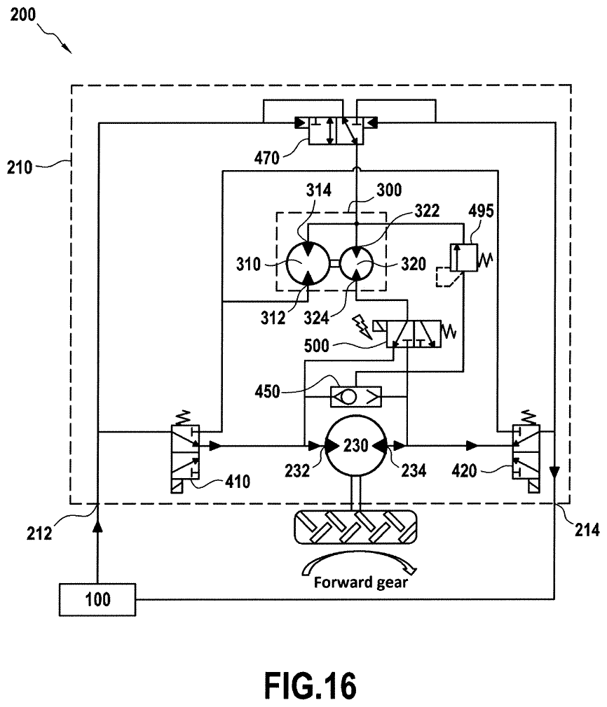

The system presented can also perform a restraining or braking function. This operation is detailed with reference to FIG. 16.

In such an operation, the primary hydraulic machine 230 is driven in rotation; it therefore has a pump operation. It delivers a pressure P1 to its second orifice 234, which is discharged via the valve 420 by the second orifice 214 of the casing 210.

The selection slide 500 is actuated such that the orifice 324 of the pressure booster is connected to the orifice 232 of the primary hydraulic machine such that the pump part of the pressure booster discharges to the orifice 232 through which the primary hydraulic machine 230 is supplied.

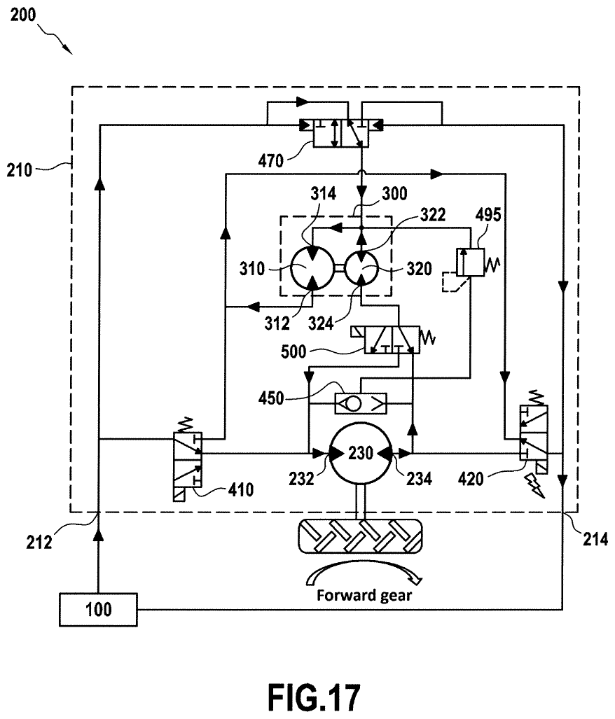

For an operation in restraint, the pressure rise function can be engaged by piloting the valve 420 and returning the selection slide 500 to its default configuration. Such a configuration is shown in FIG. 17.

The valve 420 thus seals the discharge through the second orifice 234 of the primary hydraulic machine 230. The flow rate passes through the selection slide 500 to supply the second hydraulic machine 320 through the second orifice 324 of the second hydraulic machine 320, which operates as a motor and drives in rotation the first hydraulic machine 310. The first hydraulic machine 310 then operates as a pump, and due to the difference in displacement with the second hydraulic machine 320, amplifies the pressure at the orifice 324 of the second hydraulic machine 320, and therefore at the discharge at the level of the orifice 234 of the primary hydraulic machine 230. This pressure rise amplifies the pressure deviation at the terminals of the primary hydraulic machine 230, and therefore amplifies the braking or restraining torque.

As previously, the piloting of the valve 420 makes it possible to switch to an operating mode without pressure rise.

The system as proposed is reversible, whether in traction or in restraint. The operation is similar to the operation described with reference to FIGS. 14 to 17, with reversal of the high-pressure and low-pressure branches at the orifices 212 and 214 of the casing 210.

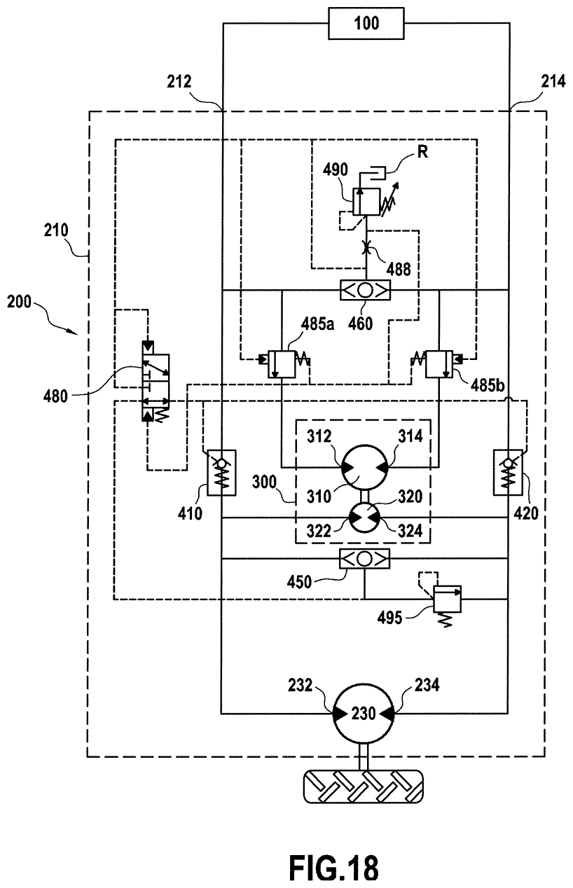

FIG. 18 shows another embodiment of a system according to one aspect of the invention.

Different elements already described with reference in particular to FIGS. 10 to 13 are in this embodiment.

In this embodiment, the pressure booster 300 is of the 4-line type, as already described in particular with reference to FIG. 5.

This 4-line pressure booster 300 structure requires duplicating the sequence valve element 485. Thus, two sequence valve elements 485a and 485b are respectively connected to the first orifice 312 and to the second orifice 314 of the first hydraulic machine 310, these two sequence valve elements 485a and 485b having an operation identical to the sequence valve elements 485 described above. The two sequence valve elements 485a and 485b typically have the same calibration. This calibration may be fixed, or can be modulated by means of a command, for example an electric command.

The operation is essentially similar to the one already described with reference in particular to FIGS. 10 to 13.

When the pressure delivered by the hydraulic energy source 100 is lower than the calibration pressure of the relief valve element 490, the two sequence valve elements 485a and 485b are not conductive, and the pressure booster 300 is therefore not commissioned.

The primary hydraulic machine 230 is supplied via the valves 410 and 420 which are conductive, either due to the direction of circulation of the fluid, or due to the piloting of their piloted chambers.

When the pressure delivered by the hydraulic energy source 100 is higher than the calibration pressure of the relief valve element 490, the latter becomes conductive and performs a relief into the tank R.

The opening of the relief valve element 490 causes the passage of a flow rate in the restriction 488, thus creating a head loss generating a pressure difference at its terminals; the pressure downstream of the restriction which is the lowest allows an opening of the sequence valve elements 485a and 485b which are then conductive, so as to allow the supply and the discharge of fluid by the first hydraulic machine 310 of the pressure booster 300. As already described previously, the first hydraulic machine 310 then operates as a motor to drive the second hydraulic machine 320 which operates as a pump, and which can deliver a pressure P2>P1 due to the ratio of the displacements between the first hydraulic machine 310 and the second hydraulic machine 320. The pressure P2 is then delivered to the primary hydraulic machine 230.

The operation in braking or restraint mode is also similar to the one already described with reference to FIGS. 12 and 13, with the exception that the two sequence valve elements 485a and 485b are piloted simultaneously.

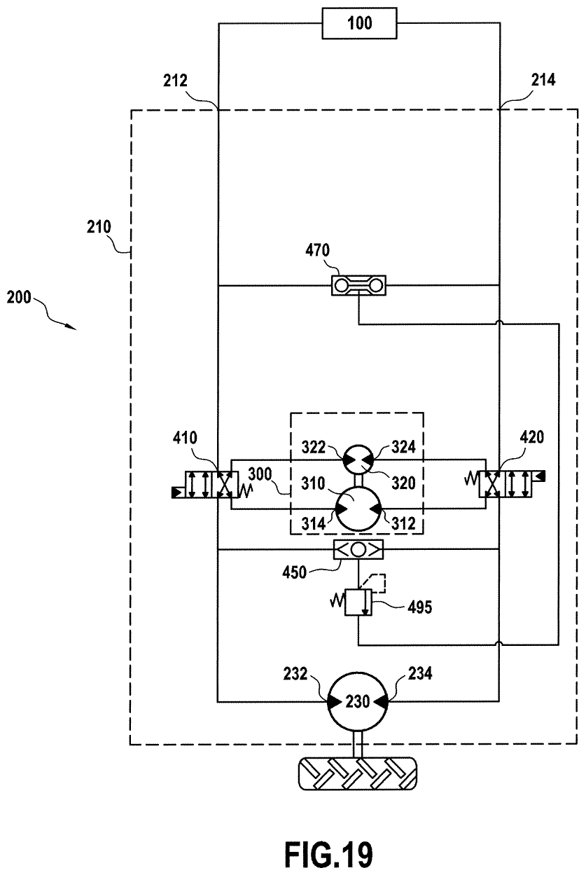

FIG. 19 shows another embodiment of a system according to one aspect of the invention.

This variant is a piloted variant, with a pressure booster 300 of the 4-line type.

In the same way as for FIGS. 14 to 17, this embodiment shows the valves 410 and 420 which are here for example solenoid valves, and which make it possible to connect the primary hydraulic machine 230 either to the hydraulic energy source 100, or to the pressure booster 300.

The system can thus isolate the pressure booster 300, for example by positioning it in a closed loop so that the pressure booster 300 is in freewheel configuration.

The valves 410 and 420 can be piloted such that the hydraulic energy source 100 supplies the first hydraulic machine 310 at a pressure P1. The latter drives in rotation the second hydraulic machine 320, and discharges a low pressure towards the hydraulic energy source 100. The second hydraulic machine 320 delivers a pressure P2>P1 due to the ratio between the displacements of the first hydraulic machine 310 and of the second hydraulic machine 320, which supplies the primary hydraulic machine 230. The second hydraulic machine 320 then forms a closed circuit with the primary hydraulic machine 230, the very high pressure P2 is thus confined in the casing 210.

The proposed system can also have an operation in restraint or in braking, with or without commissioning of the pressure booster 300 via the piloting of the valves 410 and 420, in a manner similar in particular to the embodiment described with reference to FIGS. 16 and 17.

The system as presented in the various examples thus makes it possible to achieve a rise or increase in the pressure at the terminals of the primary hydraulic machine 230 without requiring an oversizing of the hydraulic circuit or a pressure rise in the entire circuit. The pressure booster 300 as presented makes it possible to obtain a pressure difference between the two orifices 232 and 234 of the primary hydraulic machine 230 which is greater than the pressure difference between the two orifices 212 and 214 of the casing 210.

Such a local amplification of the pressure in the circuit thus makes it possible to obtain the following various advantages.

The primary hydraulic machine 230 may have a lower displacement for the same torque delivered, without requiring the sizing of the entire hydraulic circuit to be subjected to a higher pressure. The crossing capacity is thus increased without oversizing the circuit.

To obtain the same pressure and with a primary hydraulic machine of a given displacement, the hydraulic energy source 100 may then be undersized compared to a circuit without a pressure booster 300.

Furthermore, the use of a primary hydraulic machine 230 as a motor with a reduced displacement has a beneficial impact in terms of efficiency, whether or not the pressure rise function is engaged.

The system as proposed may for example be used in machinery, a vehicle, a construction machinery, an agricultural machine, or any other equipment that can be equipped with a hydraulic drive member as proposed.

For example, such a machinery may be equipped with such a system for all or part of the movement members, for example at each wheel, or on one or more axles to drive several wheels of the same axle with a single system, for example the rear axle only, the front axle only, or even at each of the wheels of the front axle or on each of the wheels of the rear axle.

Such machinery may have a circuit allowing the automatic engagement of the pressure booster on the movement members or wheels that require additional torque. This automatic activation may for example be piloted by an electronic control unit, which may for example determine the activation based on data captured on the machine, or be derived from the design of the hydraulic machine that allows it by an adequate hydraulic circuit.

Such machinery may have a circuit allowing the controlled engagement of the pressure booster on the wheels that require additional torque. This command being made by the user.

By considering a machine or machinery comprising several drive members according to the invention, the activation of the different drive members may be done independently or in combination to engage the pressure rise on all the drive members of the same part of the machine.

Although the present invention has been described with reference to specific exemplary embodiments, it is obvious that modifications and changes may be made to these examples without departing from the general scope of the invention as defined by the claims. Particularly, individual characteristics of the different illustrated/mentioned embodiments may be combined in additional embodiments. Accordingly, the description and drawings should be considered in an illustrative rather than a restrictive sense.

It is also obvious that all the characteristics described with reference to one method are transposable, alone or in combination, to one device, and conversely, all characteristics described with reference to one device are transposable, alone or in combination, to one method.

1. A system for driving a member by means of a hydraulic circuit, comprising:
a hydraulic energy source adapted to deliver a pressure in the hydraulic circuit,
a drive member, comprising:
a casing with a first casing office and a second casing orifice that are adapted to define an intake and a discharge of the casing,
a primary hydraulic machine adapted to be supplied by the hydraulic energy source, the primary hydraulic machine being housed in the casing and having a first hydraulic machine orifice and a second hydraulic machine orifice,
wherein the drive member comprises a pressure booster integrated into the casing,
said pressure booster being adapted to selectively raise the pressure, such that the pressure difference between the two orifices of the primary hydraulic machine is greater than the pressure difference between the two orifices of the casing.

2. The system according to claim 1, wherein the pressure booster is integrated into the casing such that the pressure booster is connected to the first orifice and to the second orifice of the primary hydraulic machine via conduits formed in the casing.

3. The system according to claim 1, wherein the pressure booster is configured to be engaged when the pressure difference between the two orifices of the primary hydraulic machine exceeds a threshold value.

4. The system according to claim 1, wherein the pressure booster is configured to be engaged when the pressure difference between an orifice of the casing of the hydraulic machine and the inner pressure of the casing exceeds a threshold value.

5. The system according to claim 1, further comprising at least one valve connecting the pressure booster to the first orifice and/or to the second orifice of the casing, said at least one valve being configured, when the pressure difference between the two orifices of the casing is less than or equal to a pressure threshold value, to disengage the pressure booster.

6. The system according to claim 1, further comprising at least one valve connecting the pressure booster to the first orifice and/or to the second orifice of the casing, said at least one valve being configured, when the rotational speed of the primary hydraulic machine is greater than a threshold value, to disengage the pressure booster

7. The system according to claim 1, wherein the pressure booster is adapted to take a flow rate Q1 and a pressure P1 at the first or second orifice of the casing, and deliver a flow rate Q2 and a pressure P2 to the first or second orifice of the primary hydraulic machine, such that Q2<Q1 et P2>P1.

8. The system according to claim 1, wherein the pressure booster comprises a first hydraulic machine and a second hydraulic machine that are secured in rotation, the first hydraulic machine and the second hydraulic machine having identical displacements, said first and second hydraulic machines being configured so that one has a pump operation and the other has a motor operation.

9. The system according to claim 8, wherein:
the first hydraulic machine has a first orifice and a second orifice, the first orifice being selectively connected to the orifice of the casing having the highest pressure among the two orifices of the casing, and the second orifice being selectively connected to the orifice of the casing having the lowest pressure among the two orifices of the casing,
the second hydraulic machine has a first orifice and a second orifice, the first orifice being connected to the orifice of the casing having the lowest pressure among the two orifices of the casing, and the second orifice being connected to the orifice of the primary hydraulic machine having the highest pressure via conduits arranged in the casing.

10. The system according to claim 1, wherein the pressure booster comprises a first hydraulic machine and a second hydraulic machine that are secured in rotation, the first hydraulic machine having a greater displacement than the second hydraulic machine,
said system being configured such that, for a first operating mode, the first hydraulic machine has a motor operation, and the second hydraulic machine has a pump operation, said second hydraulic machine supplying the primary hydraulic machine.

11. The system according to claim 10, wherein:
the first hydraulic machine has a first orifice and a second orifice, the first orifice being selectively connected to the orifice of the casing having the highest pressure among the two orifices of the casing, and the second orifice being selectively connected to the orifice of the casing having the lowest pressure among the two orifices of the casing,
the second hydraulic machine has a first orifice and a second orifice, the first orifice being connected to the second orifice of the first hydraulic machine, and the second orifice being connected to the orifice of the primary hydraulic machine having the highest pressure among the two orifices of the casing via conduits arranged in the casing.

12. The system according to claim 11, wherein the second orifice of the second hydraulic machine is connected to the first orifice and to the second orifice of the primary hydraulic machine via a high-pressure selector.

13. The system according to claim 11, wherein:
the first orifice of the first hydraulic machine is connected to a first calibrated valve, connected on the one hand to the first orifice of the casing and on the other hand to the second orifice of the casing, said first calibrated valve being configured to connect the first orifice of the first hydraulic machine to the orifice of the casing having the highest pressure when the pressure difference between the orifices of the casing exceeds a first calibration threshold value,
the second orifice of the first hydraulic machine is connected to a second calibrated valve, connected on the one hand to the first orifice of the casing and on the other hand to the second orifice of the casing, said second calibrated valve being configured to connect the first orifice of the first hydraulic machine to the orifice of the casing having the lowest pressure when the pressure difference between the orifices of the casing exceeds a second calibration threshold value.

14. The system according to claim 1, wherein the pressure booster comprises a first hydraulic machine and a second hydraulic machine that are secured in rotation, the first hydraulic machine having a displacement greater than the second hydraulic machine,
said system being configured such that, for a first operating mode, the first hydraulic machine has a motor operation, and the second hydraulic machine has a pump operation, said second hydraulic machine supplying the primary hydraulic machine,
wherein
the first hydraulic machine has a first orifice and a second orifice, the first orifice being connected to the first orifice of the casing, and the second orifice being connected to the second orifice of the casing,
the second hydraulic machine has a first orifice and a second orifice, the first orifice being connected to the second orifice of the primary hydraulic machine, and the second orifice being connected to the first orifice of the primary hydraulic machine, the system comprising a valve adapted to selectively isolate the first orifice of the casing from the first orifice of the primary hydraulic machine, and a valve adapted to selectively isolate the second orifice of the casing from the second orifice of the primary hydraulic machine.

15. The system according to claim 8, wherein the first hydraulic machine and/or the second hydraulic machine are radial-piston and multilobe-came hydraulic machines.

16. The system according to claim 8, wherein at least one among the first hydraulic machine and the second hydraulic machine is a variable-displacement hydraulic machine.

17. The system according to claim 1, further comprising a first valve and a second valve, the first valve being adapted to selectively connect or isolate the first orifice of the casing to the first orifice of the primary hydraulic machine, and the second valve being adapted to selectively connect or isolate the second orifice of the casing to the second orifice of the primary hydraulic machine.

18. The system according to claim 1, wherein the primary hydraulic machine is a radial-piston and multilobe-came hydraulic machine.

19. A rolling machine comprising at least one movement member and at least one system according to claim 1 adapted to selectively drive in rotation said movement member.

20. A drive member adapted to selectively drive in rotation a member, the drive member, comprising:
a casing with a first casing orifice and a second casing orifice adapted to define an intake and a discharge of the casing,
a primary hydraulic machine adapted to be supplied by a hydraulic energy source, the primary hydraulic machine being housed in the casing and having a first hydraulic machine orifice and a second hydraulic machine orifice,
said system being characterized in that the drive member comprises a pressure booster integrated into the casing, said pressure booster being adapted to selectively raise the pressure, such that the pressure difference between the two orifices of the primary hydraulic machine is greater than the pressure difference between the two orifices of the casing.
